(19) United States
(12) Patent Application Publication
(10) Pub. No.: US 2026/0302266 A1
(43) Pub. Date: Oct. 1, 2026

(54) IRON-NITROGEN-CARBON CATALYST, PREPARATION METHOD THEREFOR, AND USE THEREOF

(71) Applicants: Hainan Tropical Ocean University, Sanya (CN); Yazhou Bay Innovation Institute of Hainan Tropical Ocean University, Sanya (CN)

(72) Inventors: Yaqin Shi, Sanya (CN); Shengkui Zhong, Sanya (CN); Lijuan Wang, Sanya (CN); Zhijian Liao, Sanya (CN); Yu Li, Sanya (CN); Xiaomin Huang, Sanya (CN); Qianhui Wu, Sanya (CN); Qi Yang, Sanya (CN)

(73) Assignees: Hainan Tropical Ocean University, Sanya (CN); Yazhou Bay Innovation Institute of Hainan Tropical Ocean University, Sanya (CN)

(21) Appl. No.: 19/361,990

(22) Filed: Oct. 17, 2025

(30) Foreign Application Priority Data
Apr. 1, 2025 (CN) 202510400976.6

(51) Int. Cl. H01M 4/90; H01M 4/86; H01M 12/06

(52) U.S. Cl. CPC H01M 4/9041; H01M 4/8605; H01M 4/9083; H01M 12/06

(57) ABSTRACT

A preparation method for an iron-nitrogen-carbon catalyst comprises the following steps: dispersing a zinc salt and a ferrous salt in methanol to obtain mixture A; under heating conditions, dispersing 2-methylimidazole and 1,4-terephthalonitrile in methanol to obtain mixture B; stirring and mixing mixture A and mixture B to obtain a precursor powder, and calcining the precursor powder in an inert atmosphere to obtain an iron-nitrogen-carbon catalyst with a hierarchical porous structure.

### TECHNICAL FIELD

The present disclosure relates to the technical field of ORR catalyst preparation, and specifically to an iron-nitrogen-carbon catalyst, a preparation method therefor, and a use thereof.

### BACKGROUND

Oxidation-reduction reaction (ORR), as an important electrochemical process associated with energy devices such as fuel cells and metal-air batteries, has attracted widespread attention over the past few decades. It is well known that platinum-based electrocatalysts can perfectly solve the slow reaction kinetics of the 4e⁻-ORR, but their high cost, scarce resources, and susceptibility to poisoning render them difficult for large-scale applications. Therefore, there is an urgent need to develop efficient, durable, and non-precious electrocatalysts, which not only replace platinum-based materials in ORR but also are expected to achieve breakthroughs in large-scale applications.

Transition metal-nitrogen-carbon (M-N—C, where M=Fe, Co, Mn, etc.) catalysts exhibit excellent electrocatalytic performance and good ORR stability. Notably, iron-nitrogen-carbon (Fe—N—C) catalysts, especially those derived from ZIF8 zeolite, have become the most promising M-N—C-based ORR catalysts due to their high potential and low reaction energy barrier. However, the carbonization process of ZIF8-derived Fe—N—C catalysts usually results in a microporous structure, characterized by insufficient porosity and limited mass transfer pathways, leading to a rapid decline in catalytic performance during the reaction. Therefore, it is imperative to develop novel and efficient Fe—N—C catalysts with a hierarchical porous structure to improve their catalytic activity.

The strategic design of hierarchical porous structures is considered an efficient approach for enhancing the mass transfer in catalysts and optimizing the utilization of active sites. Specifically, micropores are crucial for exposing catalytically active sites, mesopores improve molecular mass efficiency, and macropores significantly improve mass transfer efficiency. Xie et al. (Xie Y, Yu X, Jin Z, et al. Dual-template strategy synthesis of hierarchically porous electrocatalysts for oxygen reduction reaction [J]. Advanced Sensor and Energy Materials, 2022, 1(2): 100006) utilized silica and sodium chloride as templates to create mesopores and synthesized the (FeCo)HPNC@NaCl catalyst, which exhibits ORR activity comparable to commercial Pt/C under acidic conditions. Zhu et al. (Zhu C, Shi Q, Xu B, et al. Hierarchically Porous M-N—C(M=Co and Fe) Single-Atom Electrocatalysts with Robust MNx Active Moieties Enable Enhanced ORR Performance [J]. Advanced Energy Materials, 2018, 8(29): 1801956) used a combination of silica colloids and zinc chloride as a pore-inducing template to synthesize M-N—C(M=Fe, Co), resulting in a porous structure and atomically dispersed MN₂ active sites, which exhibit excellent activity and stability in ORR performance.

Therefore, current methods mainly rely on hard template, soft template, and mixed template approaches, which lead to complex synthesis procedures, reduced productivity, and increased costs, hindering large-scale commercial manufacturing. In addition, during the template removal process, the structural integrity and porosity of the synthesized catalysts may be compromised, especially when using environmentally harmful solvents such as hydrofluoric acid and hot alkaline solutions.

### SUMMARY

The present disclosure provides an iron-nitrogen-carbon catalyst, a preparation method therefor, and a use thereof. The present disclosure provides a novel scheme for synthesizing iron-nitrogen-carbon catalysts with a hierarchical porous structure. The preparation process is simple and efficient, and structurally intact hierarchical pores can be obtained without relying on harmful reagents; meanwhile, the obtained iron-nitrogen-carbon catalysts exhibit excellent ORR activity.

The present disclosure provides the following technical solutions:

The present disclosure provides a preparation method for an iron-nitrogen-carbon catalyst, comprising the following steps:
S1. dispersing a zinc salt and a ferrous salt in methanol to obtain mixture A; under heating conditions, dispersing 2-methylimidazole and 1,4-terephthalonitrile in methanol to obtain mixture B;
S2. stirring and mixing mixture A and mixture B to obtain a precursor powder, and calcining the precursor powder in an inert atmosphere to obtain an iron-nitrogen-carbon catalyst with a hierarchical porous structure.

The applicant introduced 1,4-terephthalonitrile as a molecular template in the earlier preparation process of ZIF8 materials, which facilitates the aggregation of smaller ZIF8 precursors into larger catalyst particles. This process promotes the aggregation of individual catalytic molecules during the pyrolysis stage, helps establish a more stable solid catalytic interface, and manifests as the improvement of hierarchical porous structure and graphitization degree, ultimately yielding an iron-nitrogen-carbon catalyst with a hierarchical porous structure.

Preferably, the zinc salt is zinc nitrate, and the ferrous salt is ferrous sulfate.

Preferably, in S1, the molar ratio of zinc from the zinc salt, iron from the ferrous salt, 2-methylimidazole to 1,4-terephthalonitrile is 5:0.2:(40-42):(0.3-2).

Further preferably, the molar ratio of zinc from the zinc salt, iron from the ferrous salt, 2-methylimidazole to 1,4-terephthalonitrile is 5:0.2:(40-42):(0.7-1).

Preferably, in S1, the heating conditions are as follows: heating to 60-70° C. in an oil bath.

Preferably, in S2, the stirring and mixing time is 6-8 h, and after stirring and mixing, vacuum drying is performed at 60-80° C. for 12-24 h to obtain the precursor powder.

Preferably, in S2, the inert atmosphere is nitrogen and/or argon.

Preferably, in S2, the calcination is performed as follows: heating to 180-200° C. and holding for 2-3 h, then further heating to 800-900° C. and holding for 2-3 h.

Preferably, the heating to 180-200° C. is performed at 8-10° C./min, and the further heating to 800-900° C. is performed at 3-5° C./min.

Further preferably, in S2, the calcination is performed as follows: heating to 200° C. at 10° C./min and holding for 2 h, then further heating to 900° C. at 5° C./min and holding for 2 h.

The present disclosure further provides an iron-nitrogen-carbon catalyst, which has a hierarchical porous structure comprising micropores and mesopores, with a defect density ≥0.97 and a particle size of 550-650 nm.

Preferably, the iron-nitrogen-carbon catalyst has a specific surface area of 600-800 m²/g, a mesoporous area of 420-440 m²/g, and a pore volume of 1.0-1.5 cm³/g.

The iron-nitrogen-carbon catalyst prepared by the above method exhibits a hierarchical porous structure. Combined with the results of various characterizations such as Raman and XPS, it is demonstrated that the obtained iron-nitrogen-carbon catalyst has a hierarchical porous structure, which helps improve the mass transfer efficiency of the catalyst's active sites, and has a high defect density, which can promote oxygen adsorption; in addition, the formation of the hierarchical porous structure helps enhance the contents of pyridinic N and graphitic N, thus the finally obtained iron-nitrogen-carbon catalyst exhibits excellent ORR activity.

The present disclosure further provides a zinc-air battery, comprising the above iron-nitrogen-carbon catalyst as a catalyst material for a cathode.

Using the iron-nitrogen-carbon catalyst with a hierarchical porous structure can effectively help the zinc-air battery improve performances such as open-circuit voltage, specific capacity, and stability. It is demonstrated that the iron-nitrogen-carbon catalyst with a hierarchical porous structure exhibits remarkable battery performance and holds broad application prospects in zinc-air fuel cells.

Therefore, the present disclosure has the following beneficial effects:
(1) The present disclosure provides a novel preparation method for preparing an iron-nitrogen-carbon catalyst with a hierarchical porous structure, wherein the iron-nitrogen-carbon catalyst with a hierarchical porous structure is prepared by introducing a 1,4-terephthalonitrile molecular template.
(2) The iron-nitrogen-carbon catalyst provided by the present disclosure has a hierarchical porous structure, which can help improve the mass transfer efficiency of the catalyst's active sites, and has a high defect density, which can promote oxygen adsorption; in addition, the formation of the hierarchical porous structure helps enhance the contents of pyridinic N and graphitic N, thus the finally obtained iron-nitrogen-carbon catalyst exhibits excellent ORR activity.
(3) The zinc-air battery provided by the present disclosure utilizes the iron-nitrogen-carbon catalyst as a cathode catalyst, which significantly improves the battery's performances such as open-circuit voltage, specific capacity, and stability, demonstrating that the iron-nitrogen-carbon catalyst can be widely used as a catalyst source for zinc-air batteries.

### BRIEF DESCRIPTION OF DRAWINGS

FIG. 1 is a schematic diagram illustrating the preparation of Fe—N/C_{1,4-DB} series catalysts;

FIG. 2 shows the scanning electron microscopy images of Fe—N/C series catalysts, where a shows the SEM image of Fe—ZIF8_{1,4-DB-0.1}, b shows the SEM image of Fe—N/C_{1,4-DB-0.1}, c to e show the HRTEM images of Fe—N/C_{1,4-DB-0.1} under different magnifications, and f shows the mapping image of Fe—N/C_{1,4-DB-0.1};

FIG. 3 shows the FT-IR spectra of Fe—ZIF8 and Fe—ZIF8/_{1,4-DB-0.1};

FIG. 4 shows the performance characterization diagram of Fe—N/C_{1,4-DB-Y} series catalysts, where a shows the nitrogen adsorption-desorption isotherm curves, b shows the pore size distribution curves, c shows the XRD patterns, d shows the Raman spectra, e shows the high-resolution XPS spectra of N 1s, and f shows the high-resolution XPS spectra of Fe 2p;

FIG. 5 shows the nitrogen adsorption-desorption isotherm curve of the Fe—N/C_{1,2-DB-0.1} catalyst;

FIG. 6 shows the pore size distribution curve of the Fe—N/C_{1,2-DB-0.1} catalyst;

FIG. 7 shows the XPS spectra of Fe—N/C_{1,4-DB-Y} series catalysts;

FIG. 8 shows the N content variation of the Fe—N/C_{1,4-DB-0.1} catalyst;

FIG. 9 shows the XPS spectrum of the Fe—N/C_{1,2-DB-0.1} catalyst;

FIG. 10 shows the electrochemical performance diagram of the catalysts, where a shows the cyclic voltammetry curves, b shows the linear sweep voltammograms, c shows the Tafel slope plot, d shows the electron transfer number and hydrogen peroxide yield, e shows the chronoamperometric response, and f shows the current-time chronoamperometric response;

FIG. 11 shows the ORR performance diagram of Fe—N/C_{1,4-DB-Y} series catalysts;

FIG. 12 shows the linear sweep voltammogram of the Fe—N/C_{1,2-DB-0.1} catalyst;

FIG. 13 shows the linear sweep voltammogram of the Fe—N/C_{1,3-DB-0.1} catalyst; and

FIG. 14 shows the performance test diagram of the zinc-air battery, where a shows a schematic diagram of the zinc-air battery device, b shows the open-circuit voltage curves, c shows the polarization curve and power density, d shows a photograph of a red LED lit by the zinc-air battery using the Fe—N/C_{1,2-DB-0.1} catalyst, e shows the full discharge curves and their corresponding specific capacity, and f shows the constant current discharge curves under different current densities.

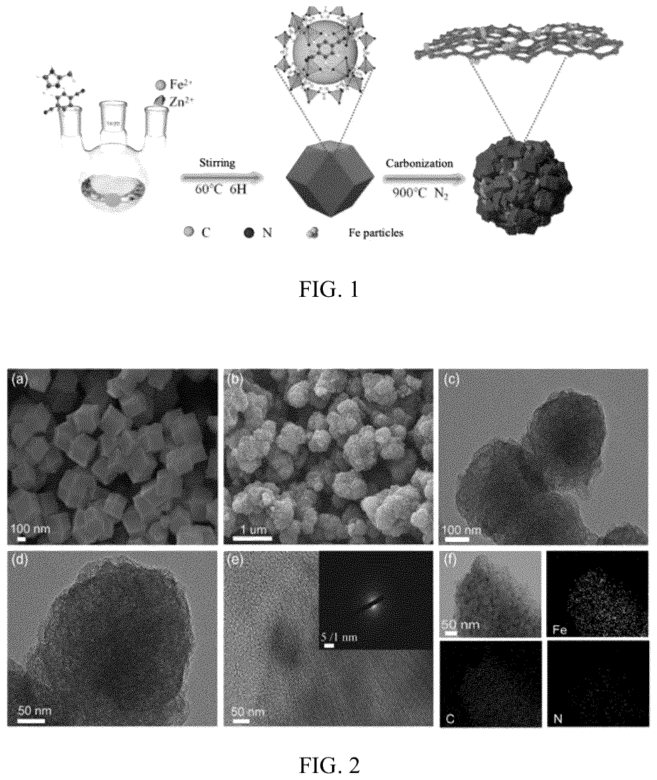

### DETAILED DESCRIPTION

The present disclosure will be further described below in conjunction with specific examples. Those of ordinary skill in the art will be able to implement the present disclosure based on these descriptions. In addition, the examples of the present disclosure involved in the following description are usually only some of the examples of the present disclosure, rather than all the examples. Therefore, based on the examples of the present disclosure, all other examples obtained by those of ordinary skill in the art without making creative efforts shall fall within the protection scope of the present disclosure.

In this section, FeSO₄·7H₂O, 2-methylimidazole (AR 98%), methanol (AR 99.5%), 1,4-terephthalonitrile (AR 98%), 1,4-phthalonitrile (AR 98%), and 1,4-isophthalonitrile (AR 98%) were all purchased from Shanghai Aladdin Biochemical Technology Co., Ltd.; Zn(NO₃)₂·6H₂O was purchased from Sinopharm Chemical Reagent Co., Ltd.; the Pt/C catalyst (20%) was purchased from Suzhou Sinero Technology Co., Ltd.; Nafion D520 (5%) was purchased from DuPont China Holding Co., Ltd. All reagents used in this section were not further purified.

### EXAMPLES

### Example 1

S1. Zn(NO₃)₂·6H₂O (1.5024 g, 5 mmol) and FeSO₄·7H₂O (0.0561 g, 0.2 mmol) were dispersed in 30 mL of methanol to obtain mixture A. 2-Methylimidazole (3.3510 g, 40.8 mmol) and 1,4-terephthalonitrile (0.10 g, 0.78 mmol) were dispersed in 30 mL of methanol, then stirred and mixed in an oil bath at 60° C. to obtain mixture B.
S2. Mixture A was added to mixture B and stirred for 6 h. A reddish-yellow precipitate was collected by centrifugation, then washed with methanol three times to remove impurities in the precipitate, and dried in a vacuum drying oven at 80° C. for 12 h to obtain Fe—ZIF8/_{1,4-DB-0.1} precursor powder.
S3. In a nitrogen atmosphere, the Fe—ZIF8/_{1,4-DB-0.1} precursor powder was pyrolyzed in a tube furnace. First, the precursor powder was heated to 200° C. at 10° C./min and held for 2 h, then further heated to 900° C. at 5° C./min and held for 2 h. Calcination yielded the Fe—N/C_{1,4-DB-0.1} catalyst.

### Example 2

S1. Zn(NO₃)₂·6H₂O (1.5024 g, 5 mmol) and FeSO₄·7H₂O (0.0561 g, 0.2 mmol) were dispersed in 30 mL of methanol to obtain mixture A. 2-Methylimidazole (3.3510 g, 40.8 mmol) and 1,4-terephthalonitrile (0.05 g, 0.39 mmol) were dispersed in 30 mL of methanol, then stirred and mixed in an oil bath at 60° C. to obtain mixture B.

S2. Mixture A was added to mixture B and stirred for 6 h. A reddish-yellow precipitate was collected by centrifugation, then washed with methanol three times to remove impurities in the precipitate, and dried in a vacuum drying oven at 80° C. for 12 h to obtain Fe—ZIF8/_{1,4-DB-0.05} precursor powder.

S3. In a nitrogen atmosphere, the Fe—ZIF8/_{1,4-DB-0.05} precursor powder was pyrolyzed in a tube furnace. First, the precursor powder was heated to 200° C. at 10° C./min and held for 2 h, then further heated to 900° C. at 5° C./min and held for 2 h. Calcination yielded the Fe—N/C_{1,4-DB-0.05} catalyst.

### Example 3

S1. Zn(NO₃)₂·6H₂O (1.5024 g, 5 mmol) and FeSO₄·7H₂O (0.0561 g, 0.2 mmol) were dispersed in 30 mL of methanol to obtain mixture A. 2-Methylimidazole (3.3510 g, 40.8 mmol) and 1,4-terephthalonitrile (0.25 g, 1.95 mmol) were dispersed in 30 mL of methanol, then stirred and mixed in an oil bath at 60° C. to obtain mixture B.
S2. Mixture A was added to mixture B and stirred for 6 h. A reddish-yellow precipitate was collected by centrifugation, then washed with methanol three times to remove impurities in the precipitate, and dried in a vacuum drying oven at 80° C. for 12 h to obtain Fe—ZIF8/_{1,4-DB-0.25} precursor powder.
S3. In a nitrogen atmosphere, the Fe—ZIF8/_{1,4-DB-0.25} precursor powder was pyrolyzed in a tube furnace. First, the precursor powder was heated to 200° C. at 10° C./min and held for 2 h, then further heated to 900° C. at 5° C./min and held for 2 h. Calcination yielded the Fe—N/C_{1,4-DB-0.25} catalyst.

### Comparative Example 1

S1. Zn(NO₃)₂·6H₂O (1.5024 g, 5 mmol) and FeSO₄·7H₂O (0.0561 g, 0.2 mmol) were dispersed in 30 mL of methanol to obtain mixture A. 2-Methylimidazole (3.3510 g, 40.8 mmol) was dispersed in 30 mL of methanol, then stirred and mixed in an oil bath at 60° C. to obtain mixture B.
S2. Mixture A was added to mixture B and stirred for 6 h. A reddish-yellow precipitate was collected by centrifugation, then washed with methanol three times to remove impurities in the precipitate, and dried in a vacuum drying oven at 80° C. for 12 h to obtain Fe—ZIF8 precursor powder.
S3. In a nitrogen atmosphere, the Fe—ZIF8 precursor powder was pyrolyzed in a tube furnace. First, the precursor powder was heated to 200° C. at 10° C./min and held for 2 h, then further heated to 900° C. at 5° C./min and held for 2 h. Calcination yielded the Fe—N/C catalyst.

### Comparative Example 2

S1. Zn(NO₃)₂·6H₂O (1.5024 g, 5 mmol) and FeSO₄·7H₂O (0.0561 g, 0.2 mmol) were dispersed in 30 mL of methanol to obtain mixture A. 2-Methylimidazole (3.3510 g, 40.8 mmol) and 1,2-phthalonitrile (0.10 g, 0.78 mmol) were dispersed in 30 mL of methanol, then stirred and mixed in an oil bath at 60° C. to obtain mixture B.
S2. Mixture A was added to mixture B and stirred for 6 h. A reddish-yellow precipitate was collected by centrifugation, then washed with methanol three times to remove impurities in the precipitate, and dried in a vacuum drying oven at 80° C. for 12 h to obtain Fe—ZIF8/_{1,2-DB-0.1} precursor powder.
S3. In a nitrogen atmosphere, the Fe—ZIF8/_{1,2-DB-0.1} precursor powder was pyrolyzed in a tube furnace. First, the precursor powder was heated to 200° C. at 10° C./min and held for 2 h, then further heated to 900° C. at 5° C./min and held for 2 h. Calcination yielded the Fe—N/C_{1,2-DB-0.1} catalyst.

### Comparative Example 3

S1. Zn(NO₃)₂·6H₂O (1.5024 g, 5 mmol) and FeSO₄·7H₂O (0.0561 g, 0.2 mmol) were dispersed in 30 mL of methanol to obtain mixture A. 2-Methylimidazole (3.3510 g, 40.8 mmol) and 1,3-isophthalonitrile (0.10 g, 0.78 mmol) were dispersed in 30 mL of methanol, then stirred and mixed in an oil bath at 60° C. to obtain mixture B.
S2. Mixture A was added to mixture B and stirred for 6 h. A reddish-yellow precipitate was collected by centrifugation, then washed with methanol three times to remove impurities in the precipitate, and dried in a vacuum drying oven at 80° C. for 12 h to obtain Fe—ZIF8/_{1,3-DB-0.1} precursor powder.
S3. In a nitrogen atmosphere, the Fe—ZIF8/_{1,3-DB-0.1} precursor powder was pyrolyzed in a tube furnace. First, the precursor powder was heated to 200° C. at 10° C./min and held for 2 h, then further heated to 900° C. at 5° C./min and held for 2 h. Calcination yielded the Fe—N/C_{1,3-DB-0.1} catalyst.

### [Performance Test]

### 1. Morphology and Structure

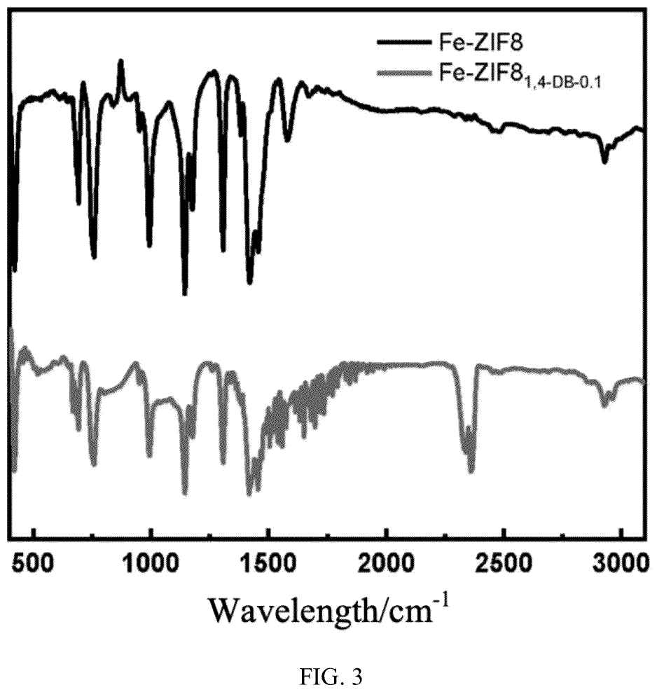

Fourier Transform Infrared Spectroscopy was used to characterize the functional groups in Fe—ZIF8 precursor powder and Fe—ZIF8/_{1,4-DB-0.1} precursor powder, and the results are shown in FIG. 3. It can be observed that in the FT-IR spectrum of Fe—ZIF-8/_{1,4-DB-0.1}, there is an obvious characteristic peak of —CN bond at approximately 2450 cm. This finding indicates that C and N have successfully incorporated into the framework of ZIF8.

Furthermore, the Fe—N/C_{1,4-DB-0.1} catalyst after calcination and carbonization was characterized by scanning electron microscopy and transmission electron microscopy, and the results are shown in FIG. 2. FIG. 2b shows the SEM image corresponding to Fe—ZIF8/_{1,4-DB-0.1} precursor powder. It can be observed that the Fe—ZIF8/_{1,4-DB-0.1} precursor powder exhibits a regular hexahedral structure with a particle size of approximately 250 nm. After calcination and carbonization of the Fe—ZIF8/_{1,4-DB-0.1} precursor powder, the Fe—N/C_{1,4-DB-0.1} catalyst was obtained, whose structure is shown in FIG. 2c. After carbonization, its surface transformed from a smooth, regular hexahedral structure to a rough spherical structure, and the particle size increased to 600 nm. Transmission electron microscopy characterization of the Fe—N/C_{1,4-DB-0.1} catalyst revealed that the carbonized Fe—N/C_{1,4-DB-0.1} catalyst exhibited an obvious porous structure. This can explain that the increase in particle size of the catalyst after carbonization is due to the formation of a loose porous structure.

FIG. 2g shows the mapping image of the Fe—N/C_{1,4-DB-0.1} catalyst. It can be observed that C, N, and Fe are uniformly distributed in the Fe—N/C_{1,4-DB-0.1} catalyst. Combined with the results of the FT-IR spectrum, it can be confirmed that C and N were successfully incorporated into the framework of ZIF8, and the basic framework of ZIF8 was retained after carbonization. Meanwhile, C and N were successfully doped into the Fe—N/C_{1,4-DB-0.1} catalyst.

### 2. Microstructure Characterization

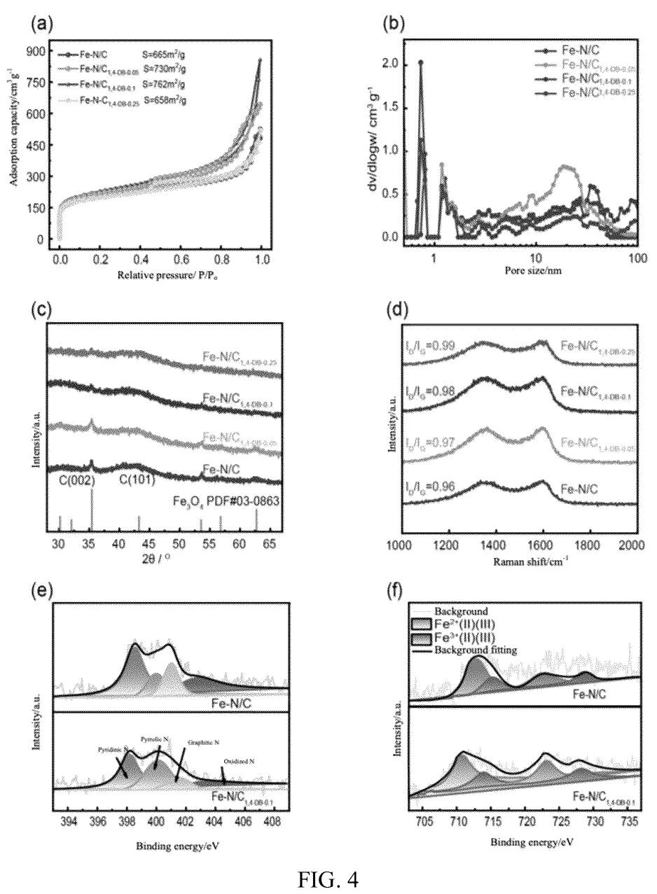

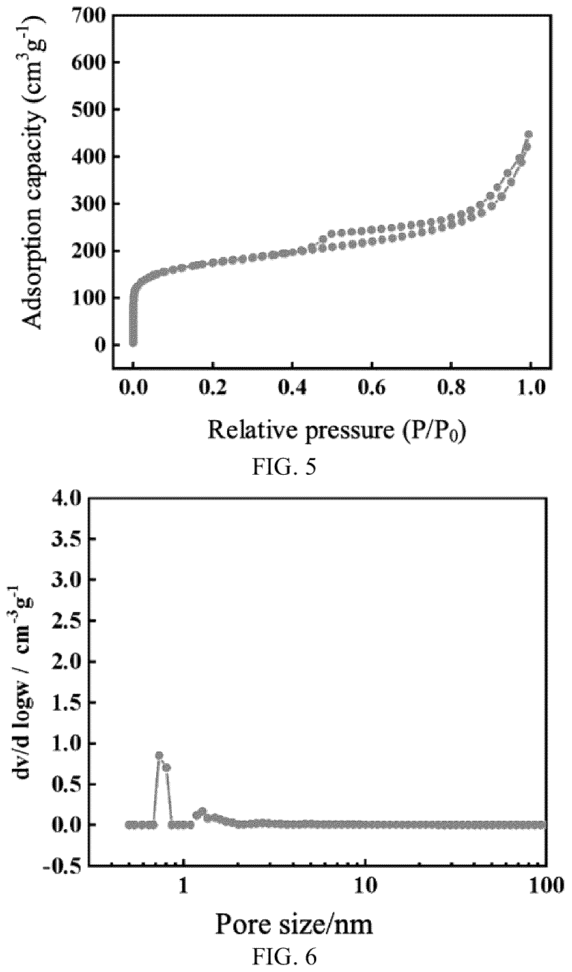

The specific surface area and pore size of Fe—N/C and Fe—N/C_{1,4-DB-Y} (Y=0.05, 0.1, 0.25) catalysts, as well as Fe—N/C_{1,2-DB-0.1} and Fe—N/C_{1,3-DB-0.1}, were evaluated using nitrogen physisorption technology, and the results are shown in FIG. 4a, FIG. 4b, FIG. 5, and FIG. 6.

FIG. 4a shows the nitrogen adsorption-desorption isotherm curves of Fe—N/C and Fe—N/C_{1,4-DB-Y} (Y=0.05, 0.1, 0.25) catalysts. It can be observed that all Fe—N/C_{1,4-DB-Y} catalysts exhibit both micropores and mesopores. At relatively high N₂ pressure (P/P₀=0.4-0.95), the presence of micropores leads to an obvious hysteresis loop. In contrast, the Fe—N/C catalyst exhibits a type IV isotherm at relatively low N₂ pressure (P/P₀=0-0.015) and no mesopore structure is observed. FIG. 4b shows the pore size distribution diagram of Fe—N/C and Fe—N/C_{1,4-DB-Y} (Y=0.05, 0.1, 0.25) catalysts. Combined with the specific surface area data in Table 1, it can be seen that the Fe—N/C_{1,4-DB-Y0.1} catalyst has the largest specific surface area (762 m²/g), the highest pore volume (1.24 cm³/g), and the largest mesoporous area (430.64 m²/g). Moreover, after introducing 1,4-terephthalonitrile as a molecular template, the Fe—N/C_{1,4-DB-Y} catalysts exhibit varying degrees of increase in specific surface area, pore volume, and mesoporous area compared with the Fe—N/C catalyst. This indicates that using 1,4-terephthalonitrile as a molecular template can introduce mesopores into ZIF-8, and changing the pore size structure of the catalyst is beneficial for improving the mass transfer efficiency of the catalyst's active sites. Furthermore, the applicant found from the results of FIG. 5 and FIG. 6 that 1,2-phthalonitrile with a similar structure cannot achieve the effect similar to 1,4-terephthalonitrile, and the Fe—N/C_{1,2-DB-0.1} catalyst using 1,2-phthalonitrile as a molecular template does not exhibit a hierarchical structure comprising micropores and mesopores.

TABLE 1
BET results

| | Micropore | Mesopore | | BET |
|---|---|---|---|---|
| | specific | specific | Pore | specific |
| | surface area | surface area | volume | surface area |
| Catalyst | (m²/g) | (m²/g) | (cm³/g) | (m²/g) |
| Fe—N—C | 78.89 | 308.98 | 0.66 | 665 |
| Fe—N/ | 90.36 | 410.53 | 0.97 | 730 |
| C_{1,4-DB-0.05} | | | | |
| Fe—N/ | 57.52 | 430.64 | 1.24 | 762 |
| C_{1,4-DB-0.1} | | | | |
| Fe—N/ | 100.69 | 407.90 | 0.74 | 658 |
| C_{1,4-DB-0.25} | | | | |

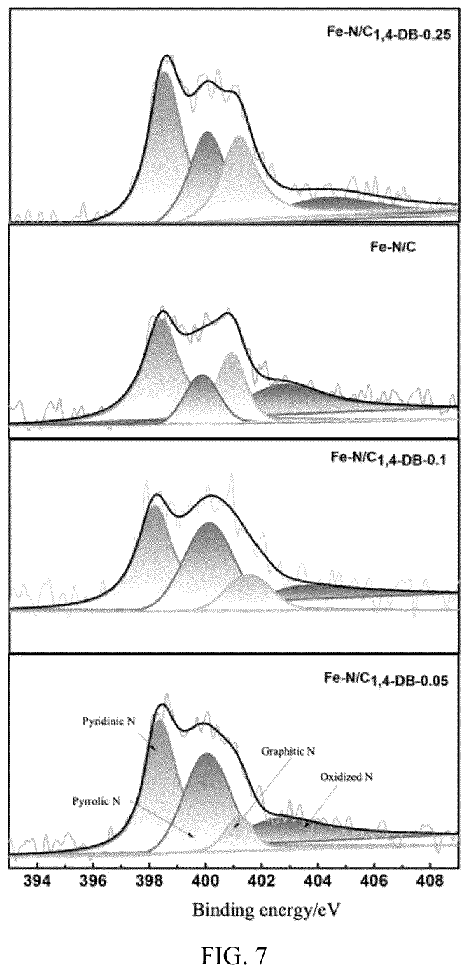

After obtaining the above distribution results of the internal pore size structure, XPS characterization was further performed on the Fe—N/C_{1,2-DB-0.1} catalyst and Fe—N/C_{1,4-DB-Y0.1} catalyst prepared with different molecular templates, and the results are shown in FIG. 4e, FIG. 4f, and FIGS. 7-9.

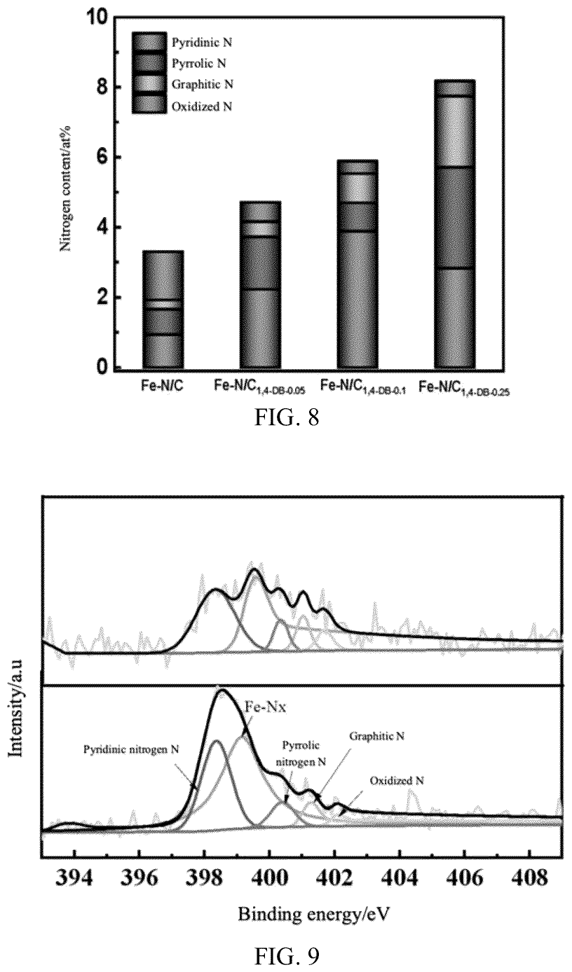

As shown in FIG. 4e, the Fe 2p spectrum exhibits characteristic peaks at 710.6 eV and 723.6 eV, corresponding to Fe²⁺(III) and Fe²⁺(II), respectively. In addition, the peaks at 714.6 eV and 727.6 eV are assigned to Fe³⁺(III) and Fe³⁺(II), respectively. FIG. 4f and FIG. 7 show that pyridinic N (398.5 eV), pyrrolic N (400.3 eV), graphitic N (401.0 eV), and oxidized N (402.7 eV) are present in all samples. Notably, pyridinic N and graphitic N constitute the main peaks of the N is XPS spectrum, which are not only beneficial for improving ORR activity but also serve as anchor sites for Fe atoms to enhance the stability of the catalytic material. Combined with the results in FIG. 8, it can be seen that the incorporation of the molecular template 1,4-terephthalonitrile leads to an increase in the contents of pyridinic N and graphitic N in the Fe—NC/1,4-DB-0.1 catalyst, thereby providing a large number of coordination environments, which facilitates the formation of active sites and thus enhances the ORR performance of the catalyst.

Furthermore, XRD and Raman characterization were performed on the Fe—N/C_{1,4-DB-Y} (Y=0.05, 0.1, 0.25) catalysts. FIG. 4c shows the corresponding XRD results, where two distinct diffraction peaks (24.2° and 42.3°) are observed, both of which are characteristic peaks of carbon. In addition, diffraction peaks with different intensities are observed at 35.4°, 53.5°, and 56.7°, corresponding to the crystal structure of ferroferric oxide. In summary, with the increase in the content of 1,4-terephthalonitrile, the intensity of the diffraction peaks of ferroferric oxide decreases gradually. FIG. 4d shows the Raman spectra with two characteristic peaks at 1335 cm-1 and 1594 cm-1. The degree of carbon defects is usually quantified by the intensity ratio of the d-band to the g-band (ID/IG). By comparing the ID/IG values of different catalysts, it can be seen that the defect density of Fe—N/C_{1,4-DB-0.1} (0.98) is greater than that of Fe—N/C (0.96). These results indicate that the incorporation of the molecular template can increase the defect density in the catalyst, thereby promoting oxygen adsorption and enhancing the ORR performance of the catalyst.

### 3. Electrochemical Performance

The test in this section was carried out on a CHI760E electrochemical workstation, with 0.1 M potassium hydroxide solution as the electrolyte and a three-electrode setup: a platinum (Pt) electrode as the counter electrode, a glassy carbon electrode (GCE) coated with catalyst ink as the working electrode, and a saturated calomel electrode (SCE) as the reference electrode. To prepare the catalyst ink, 5 mg of catalyst was dispersed in 1 mL of a solution containing 985 μL of ethanol, 5 μL of 5% Nafion solution, and 10 μL of water, and sonicated for at least 30 min.

Cyclic voltammetry (CV) and linear sweep voltammetry (LSV) experiments were performed under the conditions of a potential range of 0-1.2 V and a scan rate of 100 mV·s⁻¹. Before the experiment, purging was performed with O₂/N₂ gas for 30 min at ambient temperature. Subsequently, the oxygen reduction polarization curves (ORR polarization curves) of the catalysts were obtained under the conditions of a rotation speed of 1600 rpm, a scan rate of 5 mV·s⁻¹, and a voltage range of 0-1.2 V vs. RHE. Potential cycling was repeated until stable linear sweep voltammograms were obtained. ORR polarization curves were generated under the same test conditions using a platinum ring electrode with a ring voltage set to 1.5 V (vs RHE). These curves allowed the calculation of the electron transfer number and hydrogen peroxide yield using Equations (1) and (2).

$$n = \frac{4 Id}{Ir / N + Id} \qquad ( 1 )$$

$${HO}_{2}^{-} ( \% ) = \frac{200 Ir}{N ( {I}_{d} + {I}_{r} / N )} \qquad ( 2 )$$

In the above equations, n is the electron transfer number; HO₂⁻ is the hydrogen peroxide yield, in %; Id is the current of the glassy carbon disk, in A; Ir is the current of the platinum ring, in A; and N is the current collection efficiency of the RRDE platinum ring (N=0.37).

Electrocatalytic stability was evaluated using the chronoamperometry (IT) method for the oxygen reduction reaction (ORR). In an oxygen-saturated 0.1 M potassium hydroxide solution, a constant voltage of 0.8 V (vs RHE) was applied to the catalyst-loaded glassy carbon electrode. Cyclic voltammograms with 5000 cycles at a scan rate of 50 mV·s⁻¹ were used to induce catalyst aging.

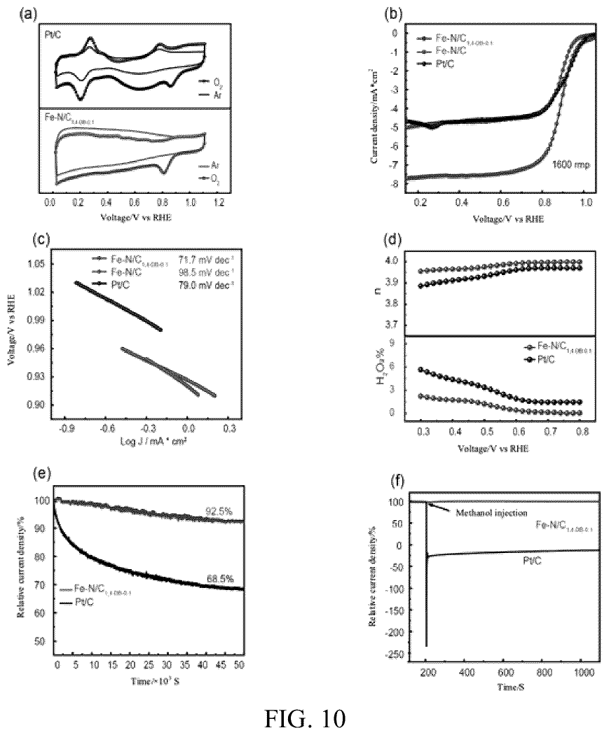

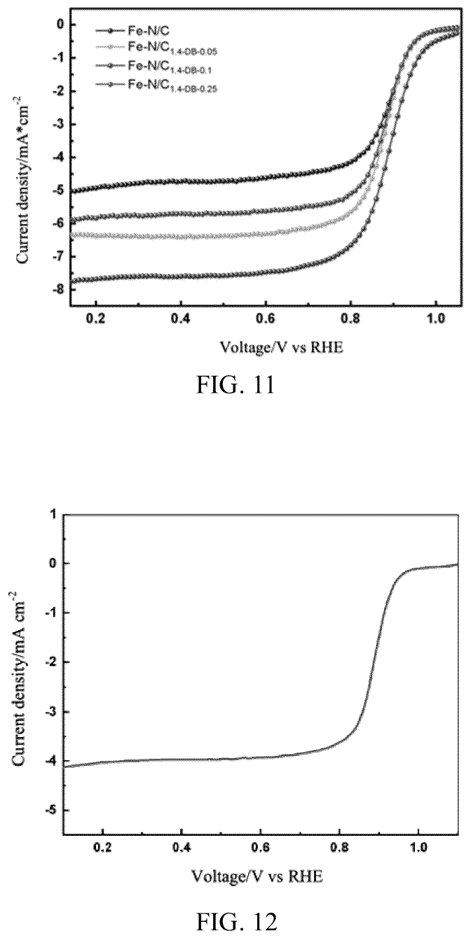

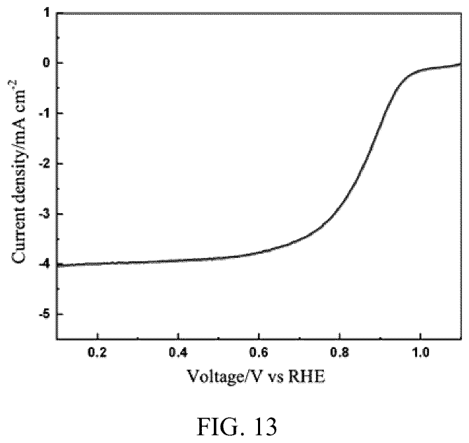

The ORR performance of the Fe—N/C_{1,4-DB-0.1} catalyst was evaluated using a three-electrode system with a rotating disk electrode. A comparative analysis was conducted on Fe—N/C and Pt/C catalysts. All tested potentials were calibrated to a reversible hydrogen electrode (RHE). Combining the cyclic voltammograms in FIG. 11 and FIG. 10a, the Fe—N/C_{1,4-DB-0.1} catalyst doped with 1,4-terephthalonitrile molecular template exhibits a larger curve area. By adjusting the incorporation amount of 1,4-terephthalonitrile, it was found that the Fe—N/C_{1,4-DB-0.1} prepared with 0.1 g of 1,4-terephthalonitrile exhibited the optimal performance. In addition, combining FIG. 11 and FIG. 10b, it can be seen that the Fe—N/C_{1,4-DB-0.1} catalyst also exhibits the highest half-wave potential (E₂=0.90 V vs RHE) and the maximum limiting current density. Compared with Fe—N/C (0.85 V vs RHE) and 20 wt % Pt/C (0.86 V vs RHE), the improvement of the Fe—N/C_{1,4-DB-0.1} catalyst is quite significant. In addition, combining the ORR performance data in FIG. 11 and FIG. 10b, it can be confirmed that the addition of the 1,4-terephthalonitrile molecular template can effectively improve ORR activity, which is consistent with the Raman results: the addition of the 1,4-terephthalonitrile molecular template can increase the defect density in the catalyst, thereby promoting oxygen adsorption and ultimately manifesting as an improvement in ORR activity. Meanwhile, this is also related to the structural characteristics of hierarchical pores in the Fe—N/C_{1,4-DB-0.1} catalyst, which helps improve the mass transfer efficiency of the catalyst's active sites and improve ORR activity. In contrast, as shown in FIG. 12 and FIG. 13, when 1,2-phthalonitrile and 1,3-isophthalonitrile were used as molecular templates, the ORR activity was lower than that when 1,4-terephthalonitrile was used. The possible reason is that when 1,2-phthalonitrile was used as a molecular template, no hierarchical pore structure formed, making it an ineffective template. Moreover, the variation trend of its N sites was different from that of 1,4-terephthalonitrile, with Fe—Nₓ formation, ultimately leading to reduced ORR activity. When 1,3-isophthalonitrile was used as a molecular template, it exhibited a direct decrease in ORR activity. It is speculated that, like 1,2-phthalonitrile, the lack of a hierarchical pore structure ultimately resulted in suboptimal ORR activity. Therefore, in the selection of molecular templates, the formation of a hierarchical pore structure is the most critical factor.

Further, the kinetic performance of ORR was evaluated using the Tafel slope, and the results are recorded in FIG. 10c. It can be observed that Fe—N/C_{1,4-DB-0.1} has the lowest Tafel slope, indicating that it experiences the lowest overpotential during the ORR catalytic process, thus exhibiting rapid dynamic characteristics. FIG. 10d shows the comparative data of the electron transfer number and hydrogen peroxide yield. It is found that the hydrogen peroxide yield of Fe—N/C_{1,4-DB-0.1} is always lower than 3%, while the electron transfer number is approximately 4.0. These data indicate that the electron transfer mechanism dominates the occurrence of the catalytic reaction during the catalytic oxidation process of Fe—N/C_{1,4-DB-0.1}.

Furthermore, the cycling stability of Fe—N/C_{1,4-DB-0.1} was evaluated using the chronoamperometry method. FIG. 10e shows that after 50,000 s of cycling, the current density of Fe—N/C_{1,4-DB-0.1} decreased by only 7.5%; compared with Fe—N/C with a 31.5% decrease in current density, it exhibits excellent cycling stability. In practical catalytic applications, stability is a key factor affecting the commercial feasibility of catalysts. Another evaluation parameter for ideal catalysts is methanol resistance. Methanol resistance tests were performed in 0.1 M potassium hydroxide on Fe—N/C_{1,4-DB-0.1} and 20 wt % Pt/C, with 1 mL of methanol injected at 200 seconds. As shown in FIG. 10f, the current of the catalyst with 1,4-terephthalonitrile molecular template shows almost no change, while the current of 20% Pt/C decreases significantly, indicating that the Fe—N/C_{1,4-DB-0.1} catalyst has strong methanol tolerance.

### 4. Zinc-Air Battery

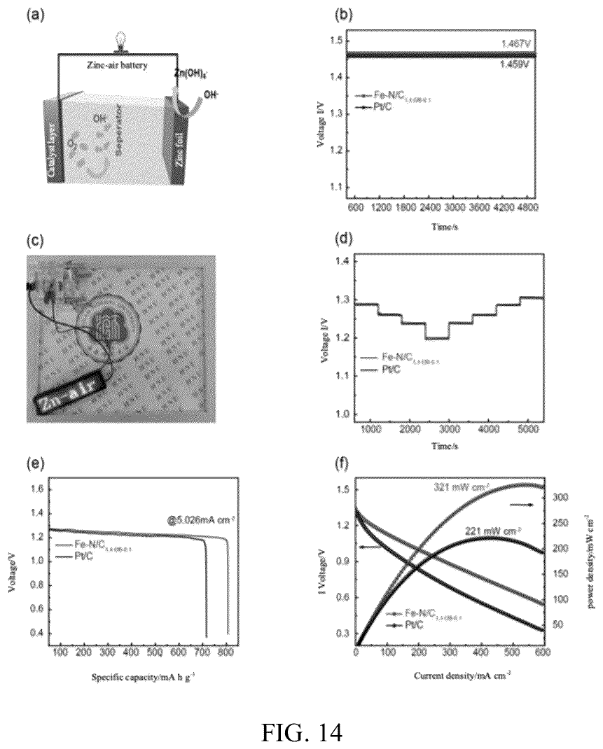

Based on the above electrochemical performance test results of the catalysts, a zinc-air battery was assembled according to FIG. 14a to further evaluate the potential application of Fe—N/C_{1,4-DB-0.1} catalyst in actual battery systems. The performance test of the zinc-air battery was performed using the Fe—N/C_{1,4-DB-0.1} catalyst as the cathode catalyst (with a glassy carbon electrode (GCE) as the electrode carrier), a platinum (Pt) electrode as the counter electrode, a saturated calomel electrode (SCE) as the reference electrode, and a 6 M potassium hydroxide solution as the electrolyte.

It can be observed from FIG. 14b and FIG. 14c that the zinc-air battery using the Fe—N/C_{1,4-DB-0.1} catalyst has an open-circuit voltage of 1.467 V and a peak power density of 321 mW cm⁻²; in contrast, the zinc-air battery prepared with the Pt/C catalyst has an open-circuit voltage of 1.459 V and a peak power density of 221 mW cm⁻². By comparison, it can be seen that the performance of the battery is effectively improved when the Fe—N/C_{1,4-DB-0.1} catalyst is used. In addition, FIG. 14d is the usage diagram of the zinc-air battery. It was found during usage that the zinc-air battery using the Fe—NC/1,4-DB-0.1 catalyst could easily power LEDs. In addition, the specific capacity of the zinc-air battery using the Fe—NC/_{1,4-DB-0.1} catalyst is 807 mAh·g⁻¹, while that of the zinc-air battery (ZAB) based on Pt/C is only 715 mAh·g⁻¹. FIG. 14f shows the constant current discharge curves of the assembled zinc-air batteries under different current densities. It can be observed that the zinc-air battery assembled with the Fe—NC/_{1,4-DB-0.1} catalyst exhibits stable discharge capability and maintains a consistent plateau at each discharge current density.

The above results can demonstrate that the Fe—NC/_{1,4-DB-0.1} catalyst exhibits remarkable battery performance and holds broad application prospects in zinc-air fuel cells.

What is claimed is:

1. A preparation method for an iron-nitrogen-carbon catalyst, comprising:
S1. dispersing a zinc salt and a ferrous salt in methanol to obtain a mixture A; dispersing 2-methylimidazole and 1,4-terephthalonitrile in methanol, and heating to 60-70° C. in an oil bath to obtain a mixture B, wherein a molar ratio among zinc from the zinc salt, iron from the ferrous salt, 2-methylimidazole, and 1,4-terephthalonitrile is 5:0.2:(40-42):(0.3-2); and
S2. stirring and mixing the mixture A and the mixture B to obtain a precursor powder, heating the precursor powder to 180-200° C. in an inert atmosphere and holding for 2-3 h, then further heating to 800-900° C. and holding for 2-3 h to obtain an iron-nitrogen-carbon catalyst with a hierarchical porous structure.

2. The preparation method according to claim 1, wherein in S2, a duration of the stirring and mixing is 6-8 h, and after the stirring and mixing, vacuum drying is performed at 60-80° C. for 12-24 h to obtain the precursor powder.

3. The preparation method according to claim 1, wherein in S2, the inert atmosphere is nitrogen and/or argon.

4. The preparation method according to claim 1, wherein the heating to 180-200° C. is performed at a rate of 8-10° C./min, and the further heating to 800-900° C. is performed a rate of at 3-5° C./min.

5. An iron-nitrogen-carbon catalyst prepared by the preparation method according to claim 1, wherein the iron-nitrogen-carbon catalyst has a hierarchical porous structure comprising micropores and mesopores, with a defect density ≥0.97 and a particle size of 550-650 nm.

6. The iron-nitrogen-carbon catalyst according to claim 5, wherein the iron-nitrogen-carbon catalyst has a specific surface area of 600-800 m²/g, a mesoporous area of 420-440 m²/g, and a pore volume of 1.0-1.5 cm³/g.

7. A zinc-air battery, comprising the iron-nitrogen-carbon catalyst according to claim 5 as a catalyst material for a cathode.

8. A zinc-air battery, comprising the iron-nitrogen-carbon catalyst according to claim 6 as a catalyst material for a cathode.

9. An iron-nitrogen-carbon catalyst prepared by the preparation method according to claim 2, wherein the iron-nitrogen-carbon catalyst has a hierarchical porous structure comprising micropores and mesopores, with a defect density ≥0.97 and a particle size of 550-650 nm.

10. An iron-nitrogen-carbon catalyst prepared by the preparation method according to claim 3, wherein the iron-nitrogen-carbon catalyst has a hierarchical porous structure comprising micropores and mesopores, with a defect density ≥0.97 and a particle size of 550-650 nm.

11. An iron-nitrogen-carbon catalyst prepared by the preparation method according to claim 4, wherein the iron-nitrogen-carbon catalyst has a hierarchical porous structure comprising micropores and mesopores, with a defect density ≥0.97 and a particle size of 550-650 nm.

12. The iron-nitrogen-carbon catalyst according to claim 9, wherein the iron-nitrogen-carbon catalyst has a specific surface area of 600-800 m²/g, a mesoporous area of 420-440 m²/g, and a pore volume of 1.0-1.5 cm³/g.

13. The iron-nitrogen-carbon catalyst according to claim 10, wherein the iron-nitrogen-carbon catalyst has a specific surface area of 600-800 m²/g, a mesoporous area of 420-440 m²/g, and a pore volume of 1.0-1.5 cm³/g.

14. The iron-nitrogen-carbon catalyst according to claim 11, wherein the iron-nitrogen-carbon catalyst has a specific surface area of 600-800 m²/g, a mesoporous area of 420-440 m²/g, and a pore volume of 1.0-1.5 cm³/g.

15. A zinc-air battery, comprising the iron-nitrogen-carbon catalyst according to claim 9 as a catalyst material for a cathode.

16. A zinc-air battery, comprising the iron-nitrogen-carbon catalyst according to claim 10 as a catalyst material for a cathode.

17. A zinc-air battery, comprising the iron-nitrogen-carbon catalyst according to claim 11 as a catalyst material for a cathode.

18. A zinc-air battery, comprising the iron-nitrogen-carbon catalyst according to claim 12 as a catalyst material for a cathode.

19. A zinc-air battery, comprising the iron-nitrogen-carbon catalyst according to claim 13 as a catalyst material for a cathode.

20. A zinc-air battery, comprising the iron-nitrogen-carbon catalyst according to claim 14 as a catalyst material for a cathode.
